(19) United States
(12) Patent Application Publication
(10) Pub. No.: US 2003/0048311 A1
(43) Pub. Date: Mar. 13, 2003

(54) System and method for computer operation guidance

(76) Inventors: Sayling Wen, Taipei (TW); Kuang Shin Lin, Taipei (TW); Guei-Long Guo, Tianjin (CN)

Correspondence Address: BIRCH STEWART KOLASCH & BIRCH, PO BOX 747, FALLS CHURCH, VA, 22040-0747, US

(21) Appl. No.: 09/947,444

(22) Filed: Sep. 7, 2001

(51) Int. Cl. G09G 5/00

(52) U.S. Cl. 345/835

(57) ABSTRACT

A user interface system with the operation guiding function is disclosed. The user interface system is implemented on a computer device installed with at least one application. The application has at least one object, and a user can use or call the object of the application through the user interface system. The user interface system includes a navigation interface module and a request responding module. The navigation interface module provides at least one prompt for each object in the application for the user to follow the prompt to enter his request in one touch. The request responding module calls the corresponding object in the application according to the request entered by the user. The invention also discloses a computer operation guiding method for the user interface system.

### BACKGROUND OF THE INVENTION

1. Field of Invention

The invention relates to a system and method for computer operation guidance, which provide function prompts that guide a user to use applications installed in a computer by simply one touch.

2. Related Art

Conventional operating systems, such as Microsoft Windows and Linux OS, have great designs and are equipped with various functions. However, often they are not sufficiently intuitive and simple to operate.

Feature-rich and sophisticated they may be, however, those very features and sophistication themselves also constitute, on many occasions, serious psychological barriers for computer-novices. These barriers automatically arise for many novice users as they attempt to use the computer not only because the typical PC OS is complex and feature-laden, but also because there are at least several procedural steps to take before any of the more simple and intuitive computer applications can be launched and used.

To power up a computer and bring up an application, a user has to boot up the system, access the physical interface of the system via devices such as a keyboard and/or mouse, locate the whereabouts of the particular application software from the desktop icon array, and then actually launch the application.

Even after the user has successfully brought the desired software application up and running, the process of using the application will most likely involve interacting with the application via one or more of several forms of user interfaces. Sometimes, a combination of these interfaces will have to be used. Typical of these user interfaces are graphical (GUIs) and multimedia types initiated through the use of a mouse, keyboard, microphone, and the like. However, since almost all of the most popular software application programs are marketed in English versions, and even the non-English version software programs inevitably contain English messages in the interfaces they provide, for non English-speaking or barely literate users, even these popular GUIs and other multimedia interfaces constitute obstacles to computer access and productive use.

Thus, an easy-to-use computer application software system should look, feel friendly and be encouraging rather than frightening. A friendly and encouraging application system should be fool-proof in that the user knows he or she will never physically damage the computer, crash the OS, or lose data simply by attempting different commands on the computer. A simple computer application system is therefore desirable for those intending to learn and use computers for the first time and then for simple daily activities such as keeping phone numbers and addresses, web browsing, and many other intuitive applications.

For example, when a user wants to use an application program under the Windows OS (Operating System), he has to drag down a menu from the function bar to find the functions he needs. In order words, a user has to memorize where various functions are in the menus listed in the function bar. For beginning users or users who are not so familiar with computers, various types of operations may greatly lower their incentive to learn how to use computers simply because they don't know what these functions are and where to find them.

Furthermore, when a user is learning a new application program, he has to try the functions provided in the menus one by one since the operation prompts given by the computer are very limited. This often leads to unexpected results and greatly lowers the efficiency of the user using the application program.

Some applications have hot keys. That is, a user can directly use some combinations of keys on the keyboard to call certain application functions without dragging down a menu to select them. Nevertheless, without pertinent prompts the user has to memorize the combination of hot keys for different function himself. Most of the time, memorizing combinations of hot keys is more difficult than using the menu to select functions.

Thus, how to effectively guide novice users to familiarize themselves with applications so as to increase their efficiency and incentive to use computer applications has become an important subject under study.

### SUMMARY OF THE INVENTION

In view of the foregoing, an objective of the invention is to provide a system and method for computer operation guidance that can increase the incentive of novice users to learn and use computers.

It is therefore an objective of the present invention to provide an intuitive single key-press navigation system for operating a computer that provides easy navigation during the use of the software services provided by a computer.

It is the other objective of the present invention to provide an intuitive single key-press navigation system for operating a computer that allows for easy navigation during the use of the software services provided by a computer without the use of a pointing device.

It is another objective of the invention is to provide a system and method for computer operation guidance that can increase the computer usage efficiency and convenience.

To achieve the above objectives, the system according to the invention is implemented in a computer device installed with at least one application. A user can use the application with at least one object through the user interface system. The user interface system includes a navigation interface module and a request responding module. The navigation interface module provides at least one prompt for each object when the user uses the application so that the user can follow the prompt and enter his request in one touch. The request responding module calls the corresponding object in the application according to the request entered by the user.

The invention also provides a computer operation guiding method, including a navigation interface generating procedure and a request responding procedure. The navigation interface generating procedure provides at least one prompt for each object when the user uses the application so that the user can follow the prompt to enter his request in one touch. The request responding procedure calls the corresponding object in the application according to the request entered by the user.

According to an embodiment of the invention, when there is a plurality of prompts, the navigation interface module further separates the prompts into a plurality of areas and provides an area selection prompt for each area. The user can enter an area selection request in one touch following the area selection prompt to select one of the areas.

According to an embodiment of the invention, the navigation interface module further provides an inter-area calling prompt. The user can follow the inter-area calling prompt for another object in the application in one touch. The request responding module then calls the corresponding object in the application according to the inter-area calling prompt.

### BRIEF DESCRIPTION OF THE DRAWINGS

The invention will become more fully understood from the detailed description given hereinbelow illustration only, and thus is not limitative of the invention, and wherein:

FIG. 1 is a block diagram illustrating the system architecture according to a preferred embodiment of the invention;

FIG. 2 is a flow chart illustrating the procedure of the computer operation guiding method according to a preferred embodiment of the invention;

FIG. 3 is a screen shot illustrating an example where the user interface system provides function prompts to a user;

FIG. 4 is a screen shot illustrating an example where the user interface system separates function prompts into several areas and provides area selection prompts; and

FIG. 5 is a schematic diagram showing an example of the relationships between the functional modules of an application.

FIG. 6 is a screen shot illustrating an example where the user interface system provides a inter-area calling prompt to a user.

### DETAILED DESCRIPTION OF THE INVENTION

The invention will be apparent from the following detailed description, which proceeds with reference to the accompanying drawings, wherein the same references relate to the same elements.

In the following description, the “objects” in the applications refer to the functional modules, files or selection items in the applications for users to select. For those skilled in the art to easily comprehend the invention, we will take functional modules as the examples of the objects of the applications.

Furthermore, the “one touch” in the invention means a single action done by a user. The basic concept of this invention is to provide a user interface, which provides the user with “prompts” corresponding to the functional modules or selectable items of the OS or applications to facilitate the operations of the user.

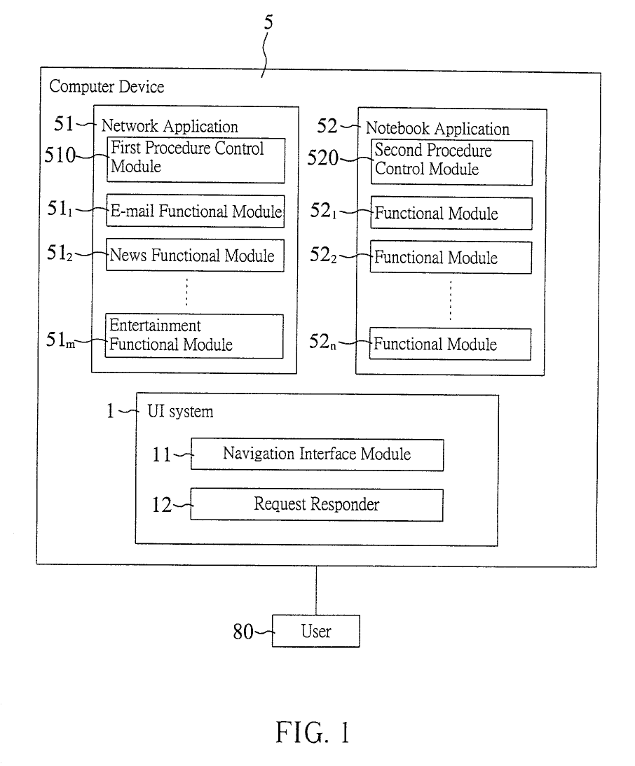

With reference to FIG. 1, a user interface system 1 according to a preferred embodiment is installed in a computer device 5. The computer device is installed with a network application 51 and a notepad application 52. The network application 51 has a first procedure control module 510 and m functional modules 51₁ through 51ₘ. The notepad application 52 has a second procedure control module 520 and n functional modules 51₁ through 51ₙ.

The user interface system 1 includes a navigation interface module 11 and a request responding module 12. The navigation interface module 11 provides a function prompt for each functional module when a user 80 uses the network application 51 or the notepad application 52, so that the user 80 can follow the function prompt to enter his request in one touch. The request responding module 12 calls the corresponding functional module in the application according to the request entered by the user 80.

In the current embodiment, the computer device 5 at least includes a CPU (Central Processing Unit), a computer-readable storage device and other peripheral device for completing the functions (e.g., input devices such as a keyboard or a mouse, and output devices such as a monitor or a printer). There are physical electronic signals to record or transmit information among the various units and devices.

The navigation interface module 11 and the request responding module 12 can be program modules stored in the computer-readable storage device. Read in and executed by the CPU, the programs can accomplish its functions via the hardware operation and electronic signal transmissions. The network application 51, the notepad application 52, the first procedure control module 510, the second procedure control module 520 and other functional modules are also programs stored in the computer-readable storage device.

In the embodiment, the one touch request input refers to the action that the user 80 can follow the function prompt on the monitor generated by the navigation interface module 11 and hit a key on the keyboard to enter his request. The keys on the keyboard can be divided into basic keys and auxiliary keys. The basic keys include ‘F1’ through ‘F12’, number keys ‘0’ through ‘9’, the four direction keys, ‘Enter’, ‘ESC’, ‘PageUp’, and ‘PageDown’. The auxiliary keys include ‘Backspace’, ‘+’, ‘−’, ‘Home’, ‘End’, ‘Ins’, and ‘Del’.

It should be noted that the user interface system could use other input method in addition to the keyboard input. For example, the user 80 can use a mouse to click his selection or use other one-touch controllers, such as the digital plates or voice recognition systems. People skilled in the art can make all equivalent modifications without departing from the spirit and scope of the invention.

Since the navigation interface module 11 provides precise function prompts for each functional module, the user 80 does not need to use a mouse to click and drag down menus or to memorize different hot key combinations to call various functional modules in the applications. He only needs to follow the function prompts provided by the navigation interface module 11 to select the functions he wants in one touch.

To make the content of the invention more comprehensible, the procedure on how the user interface system 1 guides the user to operate the computer is described hereinafter.

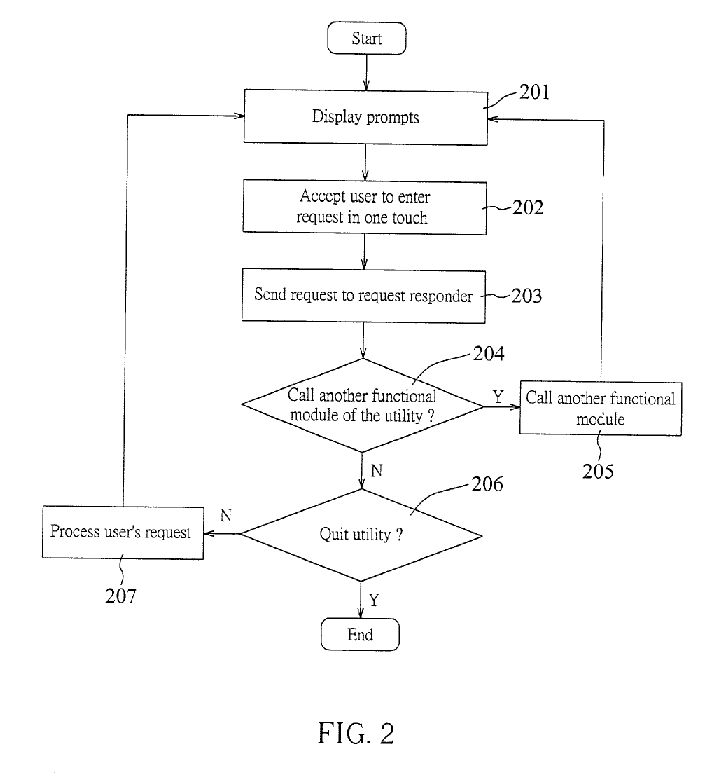

As shown in FIG. 2, when a user 80 wants to use the network application 51, the user interface system 1 first displays function prompts of all functions on a monitor in step 201. The first procedure control module 510 in the network application 51 controls which functional modules that are available for the user 80.

Step 202 accepts the keyed-in input request of the user. After receiving the request entered by the user 80, the user interface system 1 sends this request to the request responding module 12 in step 203. The request responding module 12 then determines whether the request of the user is calling another functional module in the network application 51 in step 204. If the request of the user is to call other functional modules, step 205 starts to call the functional module the user 80 wants and the procedure returns to step 201.

If the request of the user is not to call another functional module in step 204, step 206 is executed to determine whether the user wants to quit the application. If the user does not want to quit the application, then step 207 starts to process the request of the user and returns to step 201.

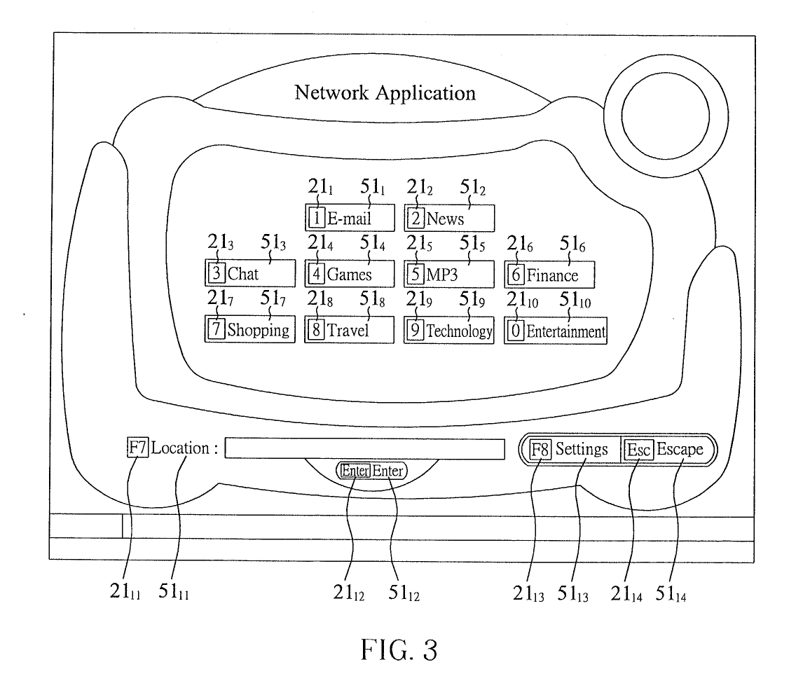

Referring to FIG. 3, when the user 80 runs the network application 51, the first procedure control module 510 provides several functional modules 51₁ to 51₁₀ for the user 80 to select. The navigation interface module 11 provides function prompts 21₁ to 21₁₀ for the functional modules 51₁ to 51₁₀, respectively. In the embodiment, the function prompts 21₁ to 21₁₀ display the key that the user 80 should hit on the keyboard in order to call a certain functional module. For example, in FIG. 3, if the user 80 wants to use the “news” functional module 51₁, that is, the user 80 wants to open the catalog of new-related websites, he can follow the function prompt 21₁ to depress the ‘1’ key to call the “news” functional module 51₁.

It should be emphasized that the user 80 can still use other input methods to select the functional module in the application 51 (e.g., using a mouse to click an icon or manually entering the website address). In other words, the conventional input methods can be implemented in the user interface system of the invention. The user 80 can use different input methods at his will.

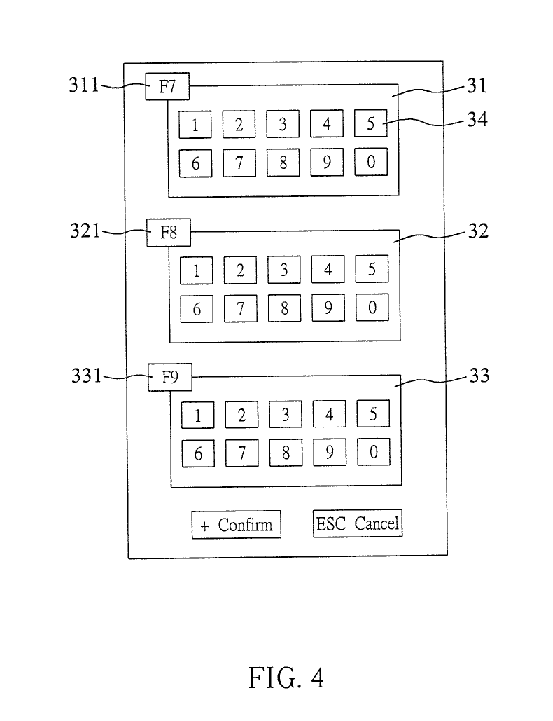

Referring to FIG. 4, the user interface system 1 according to the preferred embodiment of the invention can provide several areas on the display screen. The objects on the same screen are then divided into the areas according to their relations and convenience of use. For example, in FIG. 4, the user interface system 1 provides three areas, namely, a first area 31, a second area 32, and a third area 33. These areas have a first area selection prompt 311, a second area selection prompt 321 and a third area selection prompt 331, respectively. Several object prompts 34 are provided in each area.

When the user interface containing areas appears, the user can follow the object prompts to select the objects he needs. At the same time, when the user finishes his selection in the first are 31, the user interface system 1 automatically enters the second area 32 to wait for the input of the user. Following this procedure, the user interface system 1 can guide the user to complete the operation. The user can follow a first area selection prompt 311, a second area selection prompt 321 and a third area selection prompt 331 at any time to select any area to process.

Through the above-described guiding method, all selectable objects can be simultaneously presented and the selection can be completed by one-touch operations, thus the user interface system 1 can ensure convenience and versatility of operation. Users only need to follow the prompts to select objects step by step in the one-touch fashion.

The user interface system 1 further provides inter-area calling prompts between different functional modules. If a user is using one functional module of an application, and wants to call another functional module of the same level, the user does not need to return to the functional module in the previous level to select the other functional module.

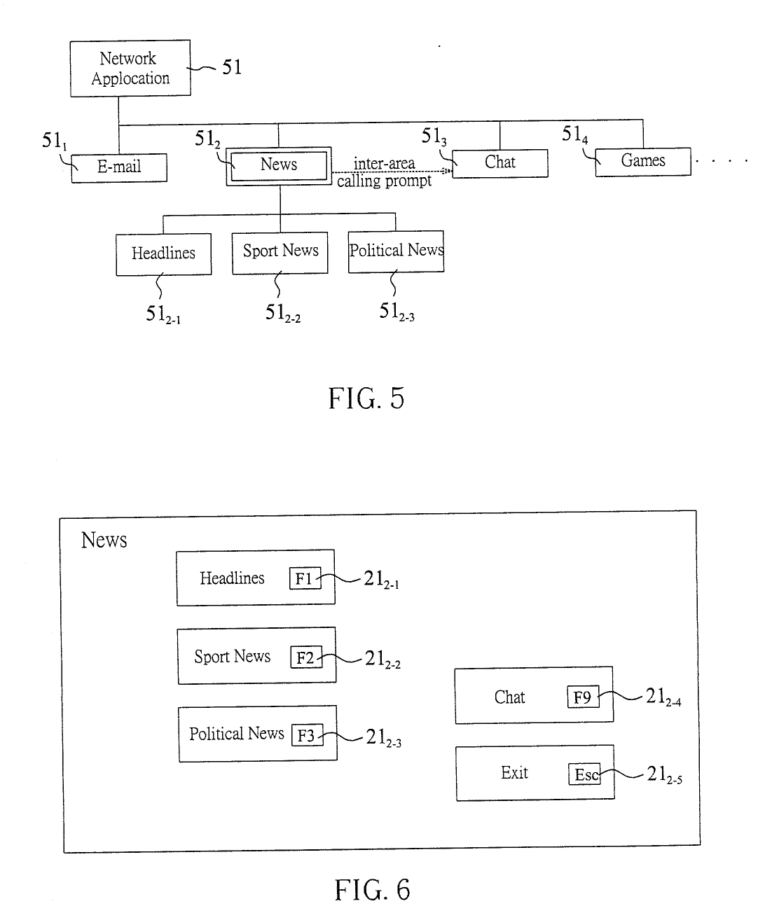

For example, FIG. 5 shows the relationships between the functional modules in the network application 51. FIG. 6 shows the screen shot when the user is using the “news” functional module 51₂. When using the “news” function module, the user can select “headlines” functional module 51₂₋₁, “sports news” functional module 51₂₋₂ or “political news” functional module 51₂₋₃ by pressing “F1”, “F2” or “F3” according to the prompts 21 ₂₋₁, 21₂₋₂ and 21₂₋₃ provided by the navigation interface module 11. The user can also select “exit” by pressing “Esc” to return to the Network Application 51 according to the prompts 21₂₋₅.

The navigation interface module also provides an inter-area calling prompt 21₂₋₄ for the “chat” function module 51₃. If the user wants to use the “chat” functional module 51₃ to have a chat with his friend via Internet while using the “news” functional module 51₂, the user can follow the inter-area calling prompt 21₂₋₄ to press the “F9” key to send an inter-area calling request. Once receiving this request, the first procedure control module 510 jumps to the “chat” function module 51₃ directly. The user does not have to return to the network application 51 to select the chat functional module 51₃. This makes the whole application operations more flexible.

Since the user interface system and computer operation guiding method according to the preferred embodiment of the invention can easily guide users to perform various operations, it effectively gives novice computer users incentives to learn and use the computer.

Furthermore, the disclosed user interface system and computer operation guiding method allows the users to enter their requests in one touch, thus it greatly enhances the convenience of use.

Certain variations would be apparent to those skilled in the art, which are considered within the spirit and scope of the claimed invention.

What is claimed is:

1. A user interface system implemented on an electronic device having at least one object, comprising:
a navigation interface module for providing at least one prompt for the object which a user can follow to enter his request in one touch; and
a request responding module for calling the corresponding object according to the request entered by the user.

2. The user interface system of claim 1, wherein
when the navigation interface module provides more than one prompts, the navigation interface module further disposes the prompts into more than one areas and provides an area selection prompt for each of the areas, so that the user can follow the area selection prompts to enter an area selection request in one touch to select one of the areas.

3. The user interface system of claim 1, wherein
the navigation interface module further provides at least one inter-area calling prompt so that the user can follow the inter-area calling prompt to enter a inter-area calling request for calling another object in one touch; and
the request responding module then follows the inter-area calling request entered by the user to call the corresponding object requested by the inter-area calling request.

4. The user interface system of claim 1, wherein one touch refers to hitting a key on a keyboard.

5. The user interface system of claim 1, wherein the object refers to a selection item of an application.

6. A computer operation guiding method implemented on an electronic device having at least one object, comprising:
providing at least one prompt for the object which a user can follow to enter his request in one touch; and
calling the corresponding object according to the request entered by the user.

7. The method of claim 6, further comprising:
disposing the prompts into a plurality of areas when providing a plurality of prompts; and
providing an area selection prompt for each of the areas so that the user can follow the area selection prompt to enter an area selection request in one touch to select one of the areas.

8. The method of claim 6, further comprising:
providing at least one inter-area calling prompt so that the user can follow the inter-area calling prompt to enter a inter-area calling request for calling another object in one touch; and
calling the corresponding object requested by the inter-area calling request entered by the user.

9. The method of claim 6, wherein one touch refers to hitting a key on a keyboard.

10. The method of claim 6, wherein the object refers to a selection item of an application.

11. A storage medium storing program codes used to direct an electronic device to perform an operation guiding method, the method comprising
providing at least one prompt for the object which a user can follow to enter his request in one touch; and
calling the corresponding object according to the request entered by the user.

12. The storage medium of claim 11, wherein the method further comprises:
disposing the prompts into a plurality of areas when providing a plurality of prompts; and
providing an area selection prompt for each of the areas so that the user can follow the area selection prompt to enter an area selection request in one touch to select one of the areas.

13. The storage medium of claim 11, wherein the method further comprises:
providing at least one inter-area calling prompt so that the user can follow the inter-area calling prompt to enter an inter-area calling request for calling another object in one touch; and
calling the corresponding object requested by the inter-area calling request entered by the user.

14. The storage medium of claim 11, wherein one touch refers to hitting a key on a keyboard.

15. The storage medium of claim 11, wherein the object refers to a selection item of an application.

16. A user interface (User Interface) system implemented on an electronic device having at least one object, comprising:
a navigation interface module for providing at least one prompt for the object which a user can follow to enter his request in one touch; and
a request responding module for calling the corresponding object according to the request entered by the user,
wherein the navigation interface module further provides at least one inter-area calling prompt so that the user can follow the inter-area calling prompt to enter a inter-area calling request for calling another object in one touch, and the request responding module then follows the inter-area calling request entered by the user to call the corresponding object requested by the inter-area calling request.

17. The user interface system of claim 16, wherein
when the navigation interface module provides more than one prompts, the navigation interface module further disposes the prompts into more than one areas and provides an area selection prompt for each of the areas, so that the user can follow the area selection prompts to enter an area selection request in one touch to select one of the areas.

18. The user interface system of claim 16, wherein
the navigation interface module further provides at least one inter-area calling prompt so that the user can follow the inter-area calling prompt to enter a inter-area calling request for calling another object in one touch.

19. The user interface system of claim 16, wherein one touch refers to hitting a key on a keyboard.

20. The user interface system of claim 16, wherein the object refers to a selection item of an application.
